(19) United States
(12) Patent Application Publication
(10) Pub. No.: US 2016/0277130 A1
(43) Pub. Date: Sep. 22, 2016

(54) WIRELESS COMMUNICATING APPARATUS

(71) Applicant: Panasonic Intellectual Property Management Co., Ltd., Osaka (JP)

(72) Inventor: Shinichiro NISHIOKA, Osaka (JP)

(21) Appl. No.: 15/068,885

(22) Filed: Mar. 14, 2016

(30) Foreign Application Priority Data
Mar. 19, 2015 (JP) 2015-056183
Dec. 3, 2015 (JP) 2015-236231

(51) Int. Cl. H04B 17/309; G09G 5/12; G09G 5/38; G06F 3/0346; H04W 76/02; H04W 24/08

(52) U.S. Cl. CPC H04B 17/309; H04W 76/023; H04W 24/08; G09G 5/38; G06F 3/0346; G09G 5/12; G09G 2370/16

(57) ABSTRACT

A wireless communicating apparatus according to the present disclosure includes: a wireless communicating device configured to perform directional wireless communication with an external device; a display for displaying information that relates to the external device; and a controller configured to control a display position of the information that relates to the external device, wherein the controller moves the display position toward an edge from a current display position, when a quality of the communication with the external device deteriorates.

### BACKGROUND

1. Technical Field

The present disclosure relates to a wireless communicating apparatus.

2. Description of the Related Art

Unexamined Japanese Patent Publication No. 2013-9180 (hereinafter referred to as “PTL 1”) discloses a wireless communicating apparatus that performs wireless communication by establishing communication with an external device selected from a plurality of external devices.

Such a wireless communicating apparatus includes an image sensor, and displays on a display an image obtained by the image sensor. Then, the wireless communicating apparatus establishes communication with an external device selected by a user out of external devices contained in the displayed image. At this time, the display of the wireless communicating apparatus displays the image of the external device over or near which terminal information of the corresponding external device is superimposed. This facilitates selection of an external device by the user.

The wireless communicating apparatus disclosed in PTL 1 first transmits a search signal while switching transmission directionality. Then, the wireless communicating apparatus receives a response signal to the search signal returned from the external device while switching reception directionality of a reception antenna. With this, the wireless communicating apparatus specifies a direction in which received signal strength of the response signal is maximized, and estimates a direction of the external device (i.e., a position or the like).

### SUMMARY

A wireless communicating apparatus according to the present disclosure includes: a wireless communicating device configured to perform directional wireless communication with an external device; a display for displaying information that relates to the external device; and a controller configured to control a display position of the information that relates to the external device. When a quality of the communication with the external device deteriorates, the controller moves the display position toward an edge from a current display position.

### BRIEF DESCRIPTION OF DRAWINGS

FIG. 1 is a schematic view of wireless communication between a wireless communicating apparatus according to this exemplary embodiment and an external device;

FIG. 2 is a block diagram of the wireless communicating apparatus according to this exemplary embodiment;

FIG. 3 is a flowchart showing one example of an operation of the wireless communicating apparatus according to this exemplary embodiment;

FIG. 4 is a view illustrating a screen example of a display in which a first external device according to this exemplary embodiment is imaged;

FIG. 5 is a view illustrating a screen example of the display in which file transfer is selected from a service selection menu according to this exemplary embodiment;

FIG. 6 is a view illustrating a screen example of the display in which a device main body according to this exemplary embodiment moves and a communication quality is maximized;

FIG. 7 is a view illustrating a screen example of the display in which the device main body according to this exemplary embodiment moves and the communication quality deteriorates;

FIG. 8 is a view illustrating a screen example of the display in which the device main body according to this exemplary embodiment moves and the communication quality is minimized;

FIG. 9 is a chart showing a change in the communication quality regarding a display position of terminal information according to this exemplary embodiment; and

FIG. 10 is a view illustrating a screen example of the display in which the device main body according to this exemplary embodiment moves and a part of the external device and the terminal information is not displayed.

### DETAILED DESCRIPTION

Hereinafter, exemplary embodiments will be described in detail with reference to the drawings.

### EXEMPLARY EMBODIMENTS

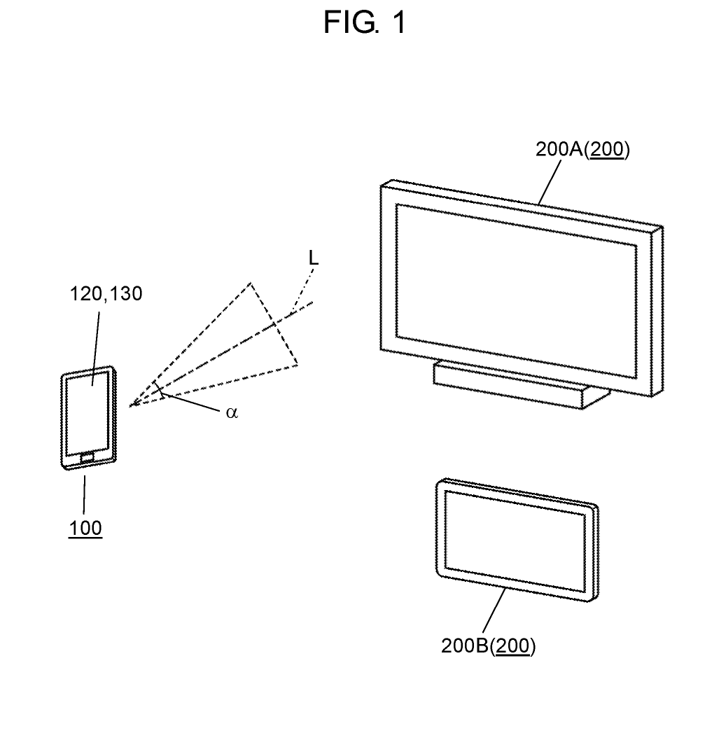

FIG. 1 is a schematic view of wireless communication between a wireless communicating apparatus according to this exemplary embodiment and an external device.

Referring to FIG. 1, wireless communicating apparatus 100 according to this exemplary embodiment performs wireless communication with external device 200, and executes a predetermined service with external device 200.

Specifically, wireless communicating apparatus 100 takes an image of external device 200 capable of performing wireless communication and displays the image. This allows a user to visually recognize external device 200 that performs wireless communication. At this time, wireless communicating apparatus 100 displays the taken image over which UI (user interface) such as terminal information is superimposed. Then, wireless communicating apparatus 100 provides a user with a predetermined service via the UI. In the following description, examples of wireless communicating apparatus 100 include, but are not limited to, an information processing device such as a mobile phone having an image pick-up sensor such as a camera. The examples may also include a pair of glasses including a wireless communicating device and a display.

In the following description, when a plurality of external devices such as first external device 200A and second external device 200B is not distinguished, hereinafter referred to as “external device 200”, for the purpose of illustration.

### <Configuration of Wireless Communicating Apparatus>

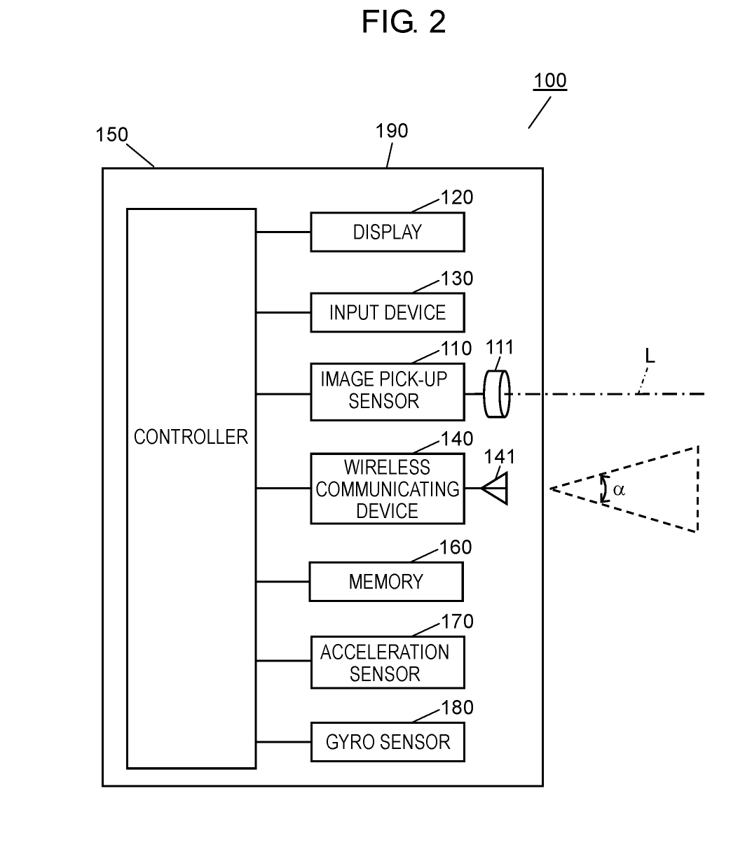

First, a configuration of wireless communicating apparatus 100 will be described with reference to FIG. 2. FIG. 2 is a block diagram of the wireless communicating apparatus according to this exemplary embodiment.

Wireless communicating apparatus 100 is an information processing device that performs wireless communication with external device 200 (i.e., a device corresponding to a different wireless communicating apparatus). Wireless communicating apparatus 100 performs highly directional wireless communication by millimeter wave communication using a 60 GHz band, for example.

Specifically, as illustrated in FIG. 2, wireless communicating apparatus 100 includes device main body 190, image pick-up sensor 110, display 120, input device 130, wireless communicating device 140, controller 150, memory 160, acceleration sensor 170, gyro sensor 180, and the like.

An example of wireless communicating apparatus 100 in the present disclosure is a smartphone. Further, acceleration sensor 170 and gyro sensor 180 are examples of a sensor detecting a motion of device main body 190.

Device main body 190 at least includes a casing. Device main body 190 is provided with image pick-up sensor 110, display 120, input device 130, wireless communicating device 140, controller 150, memory 160, acceleration sensor 170, gyro sensor 180, and the like.

Image pick-up sensor 110 includes optical system 111 and an imaging sensor (not shown), and is disposed on the casing of wireless communicating apparatus 100 on an opposite side from display 120. Image pick-up sensor 110 performs imaging of an object continuously, that is, performs imaging of a moving image.

Display 120 displays various types of information related to wireless communicating apparatus 100. For example, display 120 displays images taken by image pick-up sensor 110. Display 120 also displays information such as terminal information related to an external device whose images are taken. Input device 130 receives an input operation from the user. In the example of the present disclosure, display 120 and input device 130 are integrally configured, for example, as a touch panel (touch screen). In FIG. 2, display 120 and input device 130 are shown separately.

However, display 120 and input device 130 are not limited to an integral configuration, and may be physically separate. For example, display 120 may be a common display, and input device 130 may be configured by arrow keys disposed on the casing of wireless communicating apparatus 100.

Wireless communicating device 140 establishes highly directional wireless communication with external device 200 to perform data transfer or the like. With this, wireless communicating device 140 executes a service using wireless communication with external device 200. At this time, wireless communicating device 140 performs data transfer via directional wireless communication such as IEEE802.11ad standard. Specifically, wireless communicating device 140 performs wireless communication, for example, in a frequency band from 57.24 GHz to 65.88 GHz.

Wireless communicating device 140 includes communication antenna 141 for directional communication. Communication antenna 141 is an antenna for data communication in which transmission and reception of a high-frequency (radiowave) signal is performed. Communication antenna 141 is configured such that a line of sight (LOS: Line Of Sight) in wireless communication is parallel with optical axis L of optical system 111. In other words, a communication direction of wireless communicating device 140 has directionality in a direction along optical axis L of optical system 111. Preferably, the line of sight and optical axis L are in proximity, and more preferably, identical. With this, it is possible to reduce displacement, on display 120, between a display position of external device 200 whose image has been taken and a display position of information related to external device 200 detected in wireless communication and displayed.

Further, communication antenna 141 of wireless communicating device 140 is configured by a patch antenna or a slot antenna, for example, so that radiowave radiation angle α of radiated radiowave is within a field angle of image pick-up sensor 110.

Moreover, wireless communicating device 140 includes an RF transceiver and a baseband processor that are not illustrated. The RF transceiver converts a high-frequency signal received by communication antenna 141 into a baseband signal. Furthermore, the RF transceiver converts the baseband signal into a high-frequency signal, and transmits the converted signal through communication antenna 141. The baseband processor demodulates the baseband signal input from the RF transceiver. Moreover, the baseband processor converts a signal to be transmitted into a baseband signal, and output the converted signal to the RF transceiver.

Controller 150 performs various types of control of wireless communicating apparatus 100 by performing calculation based on data input through input device 130 or the like, and by outputting a result of the calculation. Here, controller 150 is configured by a system LSI (Large Scale Integration). Then, controller 150 includes a CPU (Central Processing Unit) and a GPU (Graphics Processing Unit), for example.

Further, controller 150 measures a communication quality of a received signal received by wireless communicating device 140. Specifically, controller 150 measures the communication quality of a received signal based on a received signal strength indicator (RSSI: Received Signal Strength Indicator) or a signal-to-noise ratio (SNR: Signal-to-Noise Ratio).

It should be noted that the system LSI constituting controller 150 may be configured by an IC (Integrated Circuit), a system LSI, a super LSI, an ultra LSI, or the like, depending on a difference of a degree of integration. Moreover, the system LSI may be configured by a dedicated circuit or a general-purpose processor. Furthermore, the system LSI may be configured by a FPGA (Field Programmable Gate Array) that may be programmed after production, or a configurable processor whose connection and setting of a circuit cell within the processor is reconfigurable. Further, wireless communicating apparatus 100 may be a component in place of the system LSI, the component being integrated based on a different technology of circuit integration (e.g., biotechnology or the like), depending on improvements in semiconductor technology or a different technology derived therefrom.

Memory 160 stores various types of data. Memory 160 is a storage medium such as a semiconductor memory, for example, a FLASH memory, a ferroelectric memory, and an HDD (Hard Disc Drive).

Acceleration sensor 170 detects acceleration of device main body 190. Based on a result of the detection by acceleration sensor 170, it is possible to detect the movement of device main body 190.

Gyro sensor 180 detects rotation of device main body 190, that is, a change in an attitude such as orientation. Other than gyro sensor 180, it is possible to employ a direction sensor to detect the rotation of device main body 190.

### <Configuration of External Device>

Next, a configuration of external device 200 will be described briefly.

External device 200 is an information processing device that is able to perform wireless communication with wireless communicating apparatus 100. External device 200 performs highly directional wireless communication by millimeter wave communication using a 60 GHz band.

Specifically, while not shown, external device 200 includes a wireless communicating device, a controller, a memory, and the like.

In the present disclosure, examples of external device 200 include a television and a tablet. Specifically, external device 200 is provided with a configuration for exerting an original function of the device, other than the wireless communicating device, the controller, and the memory.

### <Operation of Wireless Communicating Apparatus>

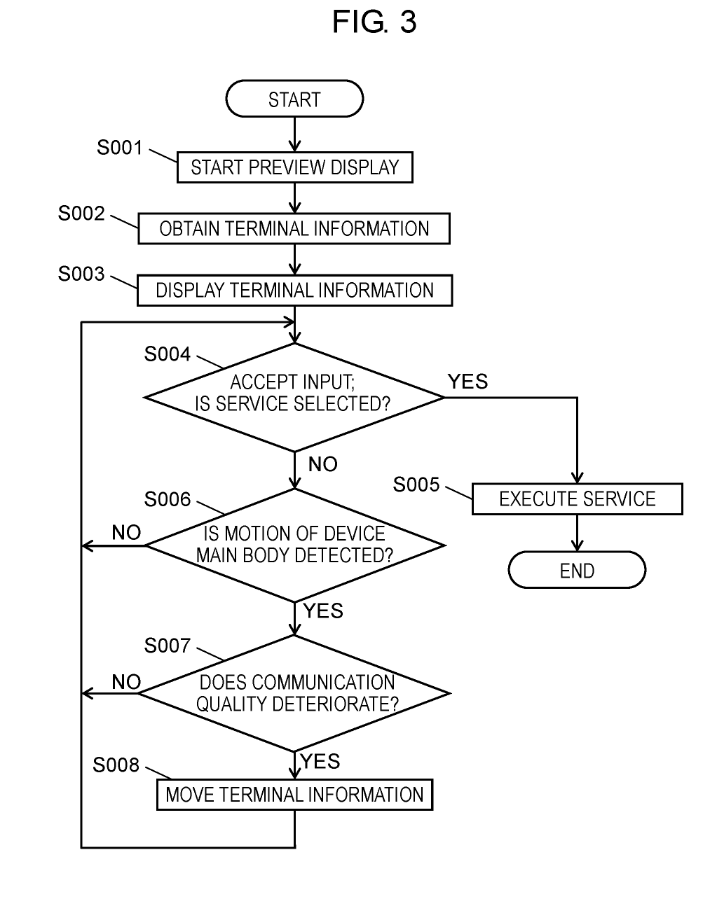

Next, an operation of wireless communicating apparatus 100 will be described with reference to FIG. 3.

FIG. 3 is a flowchart showing one example of the operation of the wireless communicating apparatus according to this exemplary embodiment.

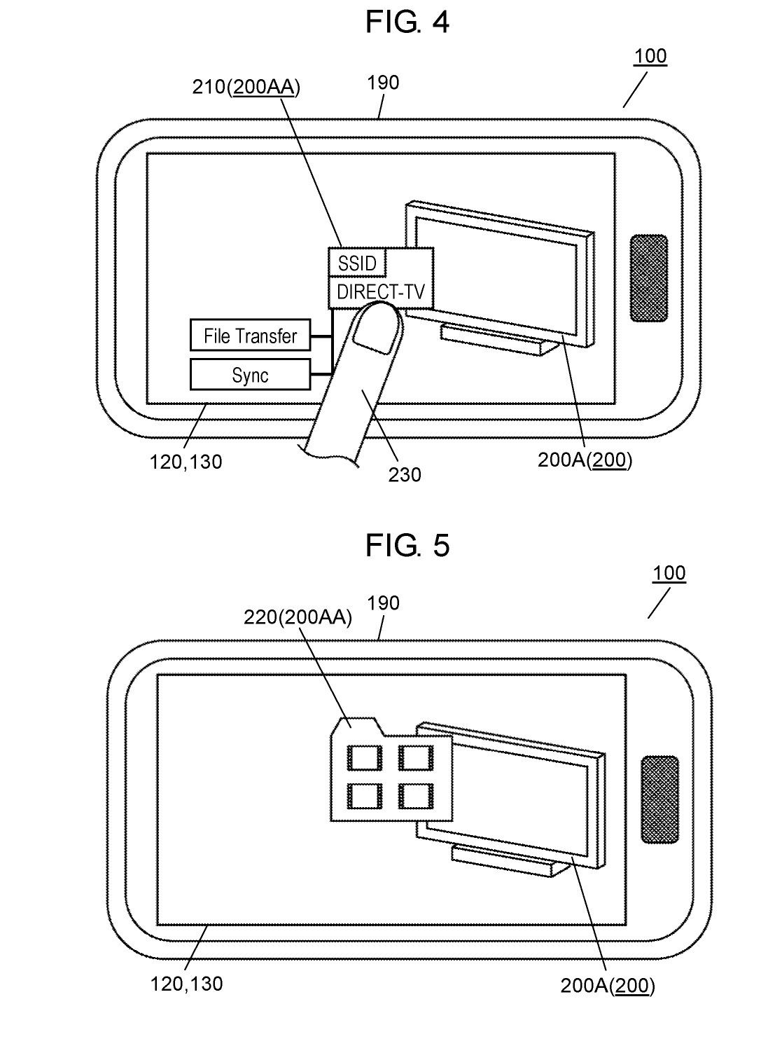

As shown in FIG. 3, controller 150 of wireless communicating apparatus 100 first receives an operation for imaging by the user via input device 130. Then, controller 150, via image pick-up sensor 110, starts imaging of a periphery of wireless communicating apparatus 100. Upon starting of imaging, controller 150 switches display 120 to a preview screen, and allows display 120 to display a preview of a taken image (Step S001). The preview display of the taken image is continuously performed in the following steps. At this time, the taken image is displayed as illustrated in FIG. 4. In other words, FIG. 4 shows as an example that a state in which first external device 200A is imaged by image pick-up sensor 110 is displayed on display 120 of wireless communicating apparatus 100.

Next, controller 150 attempts to establish wireless communication with external device 200 included within radiowave radiation angle α of wireless communicating device 140. As described above, radiowave radiation angle α is set so as to be included within the field angle of image pick-up sensor 110. Accordingly, external device 200 with which establishment of wireless communication is attempted is already imaged and displayed on display 120. At this time, if external device 200 is in a standby state for wireless communication, wireless communication is established between external device 200 and wireless communicating apparatus 100. In the example of FIG. 4, first external device 200A in the standby state for wireless communication is displayed on display 120. With this, controller 150 establishes wireless communication with first external device 200A.

Then, controller 150 obtains terminal information of first external device 200A based on a received signal from first external device 200A (Step S002). The terminal information is one example of the information.

Here, terminal information 200AA contains identification information and service information of external device 200. Further, the service information is information indicating association between a service that can be executed by external device 200 and a communication protocol used when the service is executed. The service information is previously stored in external device 200. For example, when file transfer can be executed based on a TCP/IP protocol, external device 200 stores service information associating file transfer with the TCP/IP protocol.

It should be noted that a number of the association contained in the service information may be one or more. For example, in a case in which external device 200 that prepares a plurality of services is able to select and execute one of the services, external device 200 stores service information containing a plurality of combinations of a service and an associated communication protocol. Alternatively, in a case in which external device 200 that prepares a plurality of communication protocols for a single service is able to select one of the communication protocols and execute the service, external device 200 stores service information containing combinations of the single service and an associated communication protocol for a number of the different communication protocols.

Then, controller 150 creates a service selection menu based on the obtained service information.

In the service selection menu, services that can be executed between external device 200 and wireless communicating apparatus 100 are displayed as one example of terminal information 200AA of external device 200. In other words, the service selection menu serves as a user interface from which the user may select a desired service.

It should be noted that the service selection menu may not necessarily display all of the services contained in the service information. For example, if a service that cannot be executed by wireless communicating apparatus 100 is contained in the service information, the service that cannot be executed may not be displayed in the service selection menu.

Next, controller 150 allows display 120 to display terminal information 200AA of external device 200 over the taken image on display 120 (Step S003). Specifically, as illustrated in FIG. 4, controller 150 allows display 120 to display, as terminal information 200AA, identification information 210 or the like of first external device 200A in a center of display 120. Identification information 210 severs as a user interface with which the user identifies external device 200 displayed on display 120.

Normally, the service selection menu is not displayed at this time. To display the service selection menu, the user taps identification information 210 on display 120 with finger 230 as illustrated in FIG. 4. With this, controller 150 allows display 120 to display the service selection menu in a form of a pull-down menu on display 120. For example, file transfer, data synchronization, and the like are displayed in the service selection menu. File transfer is a service of performing file transfer between wireless communicating apparatus 100 and external device 200. Data synchronization is a service of performing synchronization of data shared between wireless communicating apparatus 100 and external device 200. For example, at least one of the TCP/IP protocol, the SD protocol, and the USB (Universal Serial Bus) protocol is associated with file transfer. The SD protocol and the USB protocol are PAL (Protocol Adaptation Layer) protocol in which a wired bus protocol is adapted for an MAC (Media Access Controller) layer.

It should be noted that folder 220 shown in FIG. 5 through FIG. 8 and FIG. 10 is also one example of terminal information 200AA.

Next, controller 150 determines whether or not the user has performed a service selection operation via input device 130 (Step S004). In other words, when the user selects a service from the displayed service selection menu, controller 150 accepts the service selection operation.

Then, when the service is selected by the service selection operation of the user (YES in Step S004), controller 150 executes the selected service (Step S005). At this time, a communication protocol used for executing the service is a communication protocol associated with this service.

Now, a screen example of display 120 in which file transfer shown in FIG. 4 is selected from the service selection menu will be described specifically with reference to FIG. 5.

By selecting file transfer, folder 220 is displayed on display 120 as illustrated in FIG. 5 so that a file to be transferred can be selected. Then, the user selects a desired file in folder 220 by tapping or the like. With this, the desired file is transferred from first external device 200A to wireless communicating apparatus 100.

It should be noted that during a time period from execution start to end of the service, controller 150 may display a message notifying that the service is being executed or a progress bar indicating a status of the service being executed in the preview screen. By such a display, it is possible to urge the user to refrain to move of wireless communicating apparatus 100, and thus it is possible to prevent disconnection of wireless communication with first external device 200A.

Then, when the service execution ends, controller 150 terminates the flow.

On the other hand, there is no service selection operation (NO in Step S004), controller 150 determines whether or not a motion of device main body 190 is detected (Step S006). Here, examples of the motion of device main body 190 include movement of device main body 190 and rotation of device main body 190.

Therefore, controller 150 monitors the movement of device main body 190 based on a result detected by acceleration sensor 170. Further, controller 150 monitors the motion of device main body 190 such as rotation based on a result detected by gyro sensor 180.

At this time, if neither of the movement of device main body 190 and the rotation of device main body 190 is detected (NO in Step S006), controller 150 returns the operation to Step S004, and repeats the processing flow from the determination of the service selection operation.

On the other hand, if the motion of device main body 190 is detected (YES in Step S006), controller 150 determines whether or not a communication quality deteriorates (Step S007). In other words, controller 150 determines whether or not the communication quality of the received signal deteriorates along with the motion of device main body 190. At this time, the communication quality is determined based on whether or not the received signal strength indicator decreases, for example. As another example of the determination, the communication quality may be determined based on whether or not the signal-to-noise ratio decreases. Further, the communication quality may be determined based on whether or not both of the received signal strength indicator and the signal-to-noise ratio decrease.

Then, if the communication quality does not deteriorate (NO in Step S007), controller 150 returns the operation to Step S004, and repeats the processing flow from the determination of the service selection operation.

On the other hand, if the communication quality deteriorates (YES in Step S007), controller 150 updates a displayed content by moving the terminal information from a current display position shown on display 120 according to a level of the communication quality (Step S008). Specifically, controller 150 moves the display position on display 120 of terminal information 200AA toward an edge of display 120 in a direction opposite of the motion of device main body 190. Then, after moving terminal information 200AA, controller 150 returns the operation to Step S004, and repeats the processing flow from the determination of the service selection operation. At this time, a message or the like may be displayed on display 120, the message or the like instructing to change an orientation of device main body 190 of wireless communicating apparatus 100 to a direction in which the communication quality improves. With this, it is possible to execute a predetermined service with an appropriate communication quality.

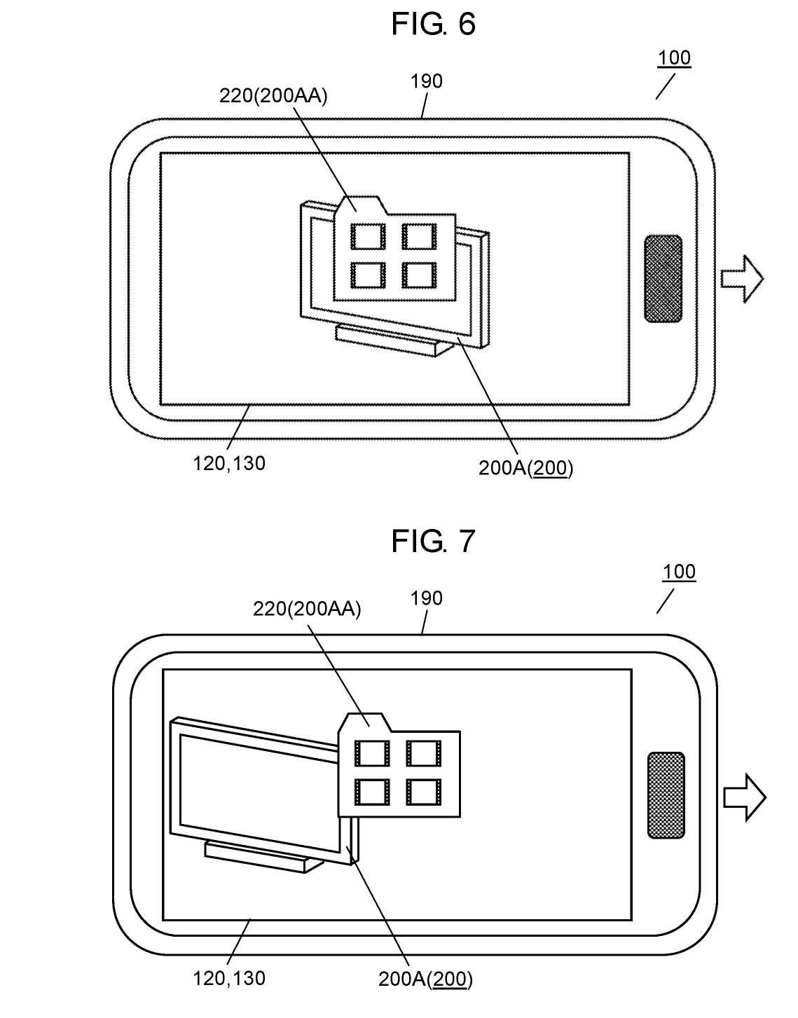

Hereinafter, the movement of the display position of the terminal information relating to external device 200 will be described with reference to FIG. 6 through FIG. 9, as well as FIG. 4 and FIG. 5.

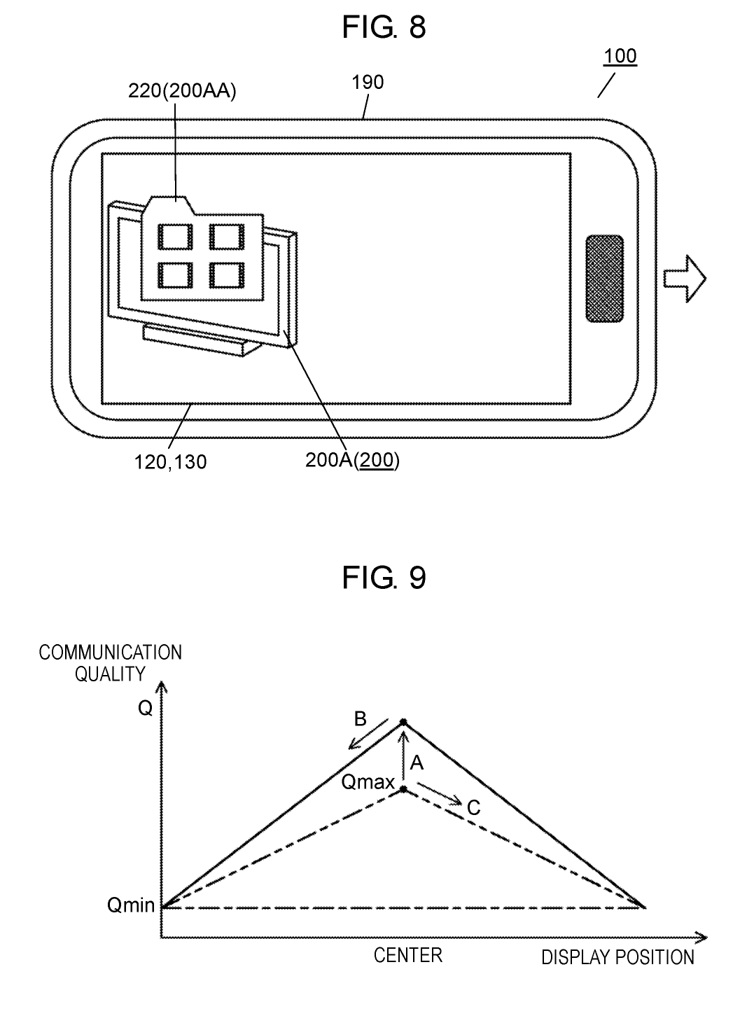

FIG. 6 is a view illustrating a screen example of the display in which the device main body according to this exemplary embodiment moves and the communication quality is maximized. FIG. 7 is a view illustrating a screen example of the display in which the device main body according to this exemplary embodiment moves and the communication quality deteriorates. FIG. 8 is a view illustrating a screen example of the display in which the device main body according to this exemplary embodiment moves and the communication quality is minimized. FIG. 9 is a chart showing a change in the communication quality regarding a display position of terminal information according to this exemplary embodiment.

First, by imaging, when communication between first external device 200A and wireless communicating apparatus 100 is established, terminal information 200AA of first external device 200A is displayed in a center of display 120 as an initial position, as illustrated in FIG. 4, regardless of a level of the communication quality. In this case, first external device 200A corresponding to terminal information 200AA is not necessarily displayed in the center of display 120. At this time, controller 150 measures communication quality Q (e.g., received signal strength indicator) of a received signal. Then, as illustrated in FIG. 9, controller 150 stores measured communication quality Q in memory 160, while maximum value Qmax is taken as an initial value.

Next, when device main body 190 moves, communication quality Q changes along with the motion of device main body 190. For example, an improvement of communication quality Q from maximum value Qmax as the initial value means that device main body 190 is directed to an orientation that is more appropriate for wireless communication with first external device 200A.

It should be noted that a communication direction of wireless communicating device 140 of wireless communicating apparatus 100 according to this exemplary embodiment has directionality along optical axis L of optical system 111 of image pick-up sensor 110. Therefore, when first external device 200A is located along optical axis L, that is, when first external device 200A is displayed in the center of display 120, communication quality Q becomes high.

In other words, if communication quality Q improves to be higher than maximum value Qmax along with the motion of device main body 190, on display 120, as illustrated in FIG. 6, the display position of first external device 200A comes closer to folder 220 (terminal information 200AA) that is displayed in the center of the display. Therefore, when the display position of first external device 200A becomes closer to the display position of folder 220, the display position of folder 220 on display 120 is not moved (changed), and the display position of folder 220 remains shown in the center.

Specifically, moving or rotating device main body 190 rightward in the figure from the state shown in FIG. 5 causes device main body 190 to face first external device 200A. At this time, the display position of first external device 200A moves to the center of display 120. Then, as illustrated in FIG. 6, the terminal information is superimposed over first external device 200A, and displayed in the center of display 120. At this time, as indicated by arrow A in FIG. 8, communication quality Q increases to be higher (greater) than maximum value Qmax set as the initial value. Therefore, during a time period in which device main body 190 is moved to a position in the center, controller 150 updates increasing maximum value Qmax while taking communication quality Q as new maximum value Qmax and stores new maximum value Qmax in memory 160. As described above, in this case, the display position of the terminal information does not change (move) and remains in the state in which the terminal information is displayed in the center of display 120.

On the other hand, moving or rotating device main body 190 further rightward in the figure from the state shown in FIG. 6 causes device main body 190 to turn away from the direction for facing first external device 200A. Therefore, as illustrated in FIG. 7, the display position of first external device 200A moves toward a left edge from the center of display 120. At this time, communication quality Q of the received signal deteriorates, as indicated by arrow B in FIG. 9, along with the motion of device main body 190. In this case, even if the communication quality of the received signal deteriorates, maximum value Qmax of communication quality Q is maintained in memory 160 without being updated.

Then, controller 150 moves the display position of the terminal information that is displayed in the center of display 120 according to the motion of device main body 190.

Specifically, when communication quality Q deteriorates, controller 150 moves the display position of the terminal information on display 120 in the direction opposite of the motion of device main body 190. In the example shown in FIG. 6, moving or rotating device main body 190 rightward in the figure (direction of a void arrow) moves the display position of the terminal information on display 120 toward the left edge as illustrated in FIG. 8. In other words, on display 120, the display position of first external device 200A is moved in the direction opposite of the motion of device main body 190. Therefore, controller 150 also moves the display position of the terminal information to the same direction. With this, the terminal information is moved by following first external device 200A.

At this time, controller 150 obtains a movement amount of the terminal information on display 120 based on a change in communication quality Q between maximum value Qmax and minimum value Qmin. Specifically, first, as device main body 190 and first external device 200A come close to a position for facing each other, maximum value Qmax is updated, changed from the initial value, and recorded as a value when device main body 190 and first external device 200A face each other. On the other hand, minimum value Qmin is obtained as a value of communication quality Q with which wireless communication with external device 200 may be established. The value of communication quality Q is previously held in memory 160. It should be noted that minimum value Qmin corresponds to communication quality Q when first external device 200A is positioned near an outer border of a radio emission area of wireless communicating device 140. Specifically, this corresponds to a case in which first external device 200A is displayed near an outer edge of display 120, as illustrated in FIG. 8.

In other words, when communication quality Q takes maximum value Qmax, first external device 200A faces device main body 190, and a taken image is displayed near the center of display 120. Thus, controller 150 allows display 120 to display the terminal information of first external device 200A in the center of display 120.

On the other hand, when communication quality Q takes minimum value Qmin, first external device 200A turns away from the direction for facing device main body 190, and therefore the taken image is displayed near the edge of display 120. Thus, controller 150 allows display 120 to display the terminal information of first external device 200A near the edge of display 120. Then, in a case in which first external device 200A moves between the center and near the edge of display 120 (when Qmin<communication quality Q<Qmax), controller 150 sets the display position of the terminal information according to received communication quality Q by linear interpolation of minimum value Qmin from stored maximum value Qmax of communication quality Q. In other words, according to measured communication quality Q, controller 150 obtains the display position for the terminal information of first external device 200A by linear interpolation and allows display 120 to display the obtained terminal information on display 120. As a result, the terminal information is moved by following the movement of first external device 200A on display 120, and is displayed.

It should be noted that as communication quality Q becomes closer to minimum value Qmin, a communication rate between first external device 200A and device main body 190 as well as a communication quality of the information deteriorate. Accordingly, communication time and a radiowave intensity in transmission and reception increase.

Therefore, the position of the terminal information is moved according to communication quality Q, and displayed on display 120. With this, the user visually recognizes deterioration of communication quality Q. As a result, it is possible to urge the user to change the orientation of wireless communicating apparatus 100 to a direction in which communication quality Q improves, that is, a direction in which first external device 200A is displayed in the center of display 120.

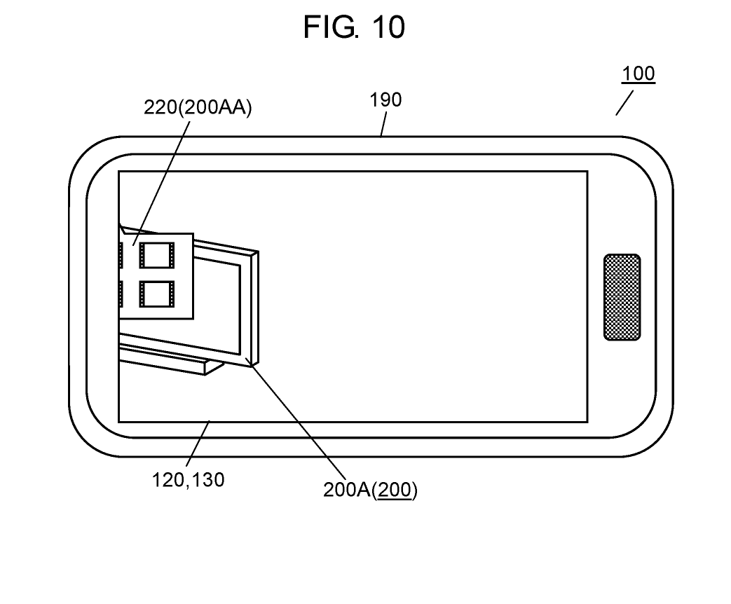

Further, in a case in which detected communication quality Q is compared with minimum value Qmin stored in memory 160, and proved to be smaller than minimum value Qmin with which establishment of wireless communication is difficult or not possible, a part or an entirety of first external device 200A is not displayed on display 120 as illustrated in FIG. 10. In other words, controller 150 controls such that a part or an entirety of the terminal information of first external device 200A is not displayed on display 120. With this, it is possible to make the user recognize that establishment of wireless communication between first external device 200A and device main body 190 is difficult or not possible. As a result, it is possible to urge the user again to change the orientation of device main body 190 by changing the orientation of device main body 190 to establish wireless communication with first external device 200A.

It should be noted that while the case in which device main body 190 is moved or rotated rightward in the figure from the state shown in FIG. 4 is described in the above, the present disclosure is not limited to such an example. For example, the same processing as described above is performed in a case in which device main body 190 is moved or rotated leftward in the figure from the state shown in FIG. 4. With this, the display position of the terminal information moves by following the movement of first external device 200A to be imaged, and is displayed on display 120.

Specifically, moving or rotating device main body 190 leftward in the figure from the state shown in FIG. 4 causes an imaging center of device main body 190 to further turn away from the direction of first external device 200A. Therefore, communication quality Q of the received signal deteriorates, as indicated by arrow C in FIG. 9, from maximum value Qmax set as the initial value. Further, as described above, controller 150 allows to display the terminal information corresponding to communication quality Q at a display position linearly-interpolated between maximum value Qmax and minimum value Qmin. However, maximum value Qmax of communication quality Q is the same as maximum value Qmax set as the initial value. In other words, communication quality Q at this time is smaller than communication quality Q in the case in which device main body 190 is moved or rotated rightward as described with reference to FIG. 6. Therefore, a movement amount of the display position of the terminal information for deterioration of communication quality Q becomes greater than a movement amount in a case in which device main body 190 moves or rotates rightward.

As described above, the terminal information is moved by following the movement of first external device 200A on display 120. Therefore, when first external device 200A is displayed near the outer edge of display 120, the terminal information is also displayed at first external device 200A by being superimposed.

As described above, wireless communicating apparatus 100 according to this exemplary embodiment includes: wireless communicating device 140 configured to perform directional wireless communication with external device 200; a display for displaying information that relates to the external device; and a controller configured to control a display position of the information that relates to the external device. Controller 150 is configured to move the display position toward an edge from a current display position, when a quality of the communication with the external device deteriorates.

According to this configuration, external device 200 and information such as the terminal information of external device 200 are displayed on display 120. At this time, when communication quality Q of radiowaves received from external device 200 deteriorates depending on the motion of device main body 190, controller 150 moves the display position of the terminal information to be displayed toward near the edge of display 120 from the current display position. In other words, the user may be notified, by the movement of the display position for terminal information displayed on display 120, of the deterioration in communication quality Q of the radiowaves. This allows the user to determine whether or not communication quality Q with external device 200 is appropriate. As a result, it is possible to urge the user to direct wireless communicating apparatus 100 to a direction in which communication quality Q is higher. Then, while high communication quality Q is maintained, a required service may be executed in an optimal way between wireless communicating apparatus 100 and external device 200 via the terminal information.

According to wireless communicating apparatus 100 of this exemplary embodiment, the information that relates to external device 200 may be information for operating external device 200. With this, a required service may be executed between wireless communicating apparatus 100 and external device 200 via the information displayed on display 120.

Controller 150 of wireless communicating apparatus 100 according to this exemplary embodiment may maintain the display position of the information when the quality of the communication with external device 200 improves. With this, the user is able to determine that communication quality Q between wireless communicating apparatus 100 and external device 200 at the current display position is appropriate. Therefore, it is possible to urge the user to change the direction of wireless communicating apparatus 100 only when communication quality Q deteriorates.

Further, wireless communicating apparatus 100 according to this exemplary embodiment may further include a sensor configured to detect motion of wireless communicating apparatus 100, and the display position of the terminal information may be changed if the sensor detects the motion of wireless communicating apparatus 100.

According to this configuration, it is possible to easily determine if the motion such as a movement of wireless communicating apparatus 100 is not appropriate with respect to communication quality Q. With this, it is possible to make the user recognize to direct wireless communicating apparatus 100 to an appropriate direction with respect to external device 200.

Further, controller 150 of wireless communicating apparatus 100 according to this exemplary embodiment may move the display position of the terminal information toward a direction opposite of a direction of the motion detected by the sensor, when communication quality Q deteriorates.

According to this configuration, when communication quality Q deteriorates, the terminal information is displayed while the terminal information is moved to the direction opposite of the motion of wireless communicating apparatus 100 that is detected by the sensor. With this, it is possible to make the user recognize deterioration of communication quality Q between external device 200 and wireless communicating apparatus 100.

Moreover, wireless communicating device 140 according to this exemplary embodiment may further include an image pick-up sensor configured to obtain an image, and an optical axis of the image pick-up sensor may be identical with a communication direction of wireless communicating apparatus 100.

According to this configuration, it is possible to reduce displacement between the display position of external device 200 that has been imaged and displayed on display 120 and the display position of the terminal information.

### Other Exemplary Embodiments

As described above, the exemplary embodiment has been described as an example of the technique disclosed in the present application.

However, the technique according to the present disclosure is not limited to the above exemplary embodiment, and may be applied to exemplary embodiments to which modifications, replacements, additions, omissions, and the like are made.

Further, a new exemplary embodiment may be achieved by combining the components described in the exemplary embodiment.

Thus, other exemplary embodiments are described by example in the following.

For example, according to this exemplary embodiment, wireless communicating apparatus 100 may be a tablet, a PC, a television, an e-book reader, a music player, a gaming machine, or the like. Further, wireless communicating apparatus 100 may be a pair of glasses having the components described above other than the image pick-up sensor. In this case, the terminal information is displayed on a lens according to external device 200 in a direction that a person wearing the pair of glasses sees. Then, a required service can be executed by operating the displayed terminal information. Moreover, when the direction that a person wearing the pair of glasses sees is moved to a direction turning away the direction of external device 200, the terminal information is also moved along with the movement. With this, it is possible to recognize deterioration of communication quality Q. As a result, it is possible to urge the user to see a direction in which communication quality Q is high. Similarly, external device 200 is not limited to a television and a tablet, and may be a PC, a digital camera, a smartphone, a music player, a gaming machine, or the like.

Moreover, in this exemplary embodiment, the components such as controller 150, for example, may be configured by dedicated hardware. Alternatively, it is possible to employ a configuration in which software appropriate for each of the components is executed. Further, each of the components may be configured such that a program executor such as a CPU or a processor reads and executes a software program stored in a storage medium such as a hard disk or a semiconductor memory.

Further, a comprehensive or specific aspect of the present disclosure may be a configuration realized by a system, a method, an integrated circuit, a computer program, or a storage medium such as a computer-readable CD-ROM.

Moreover, a comprehensive or specific aspect of the present disclosure may be a configuration realized by any combination of a system, a method, an integrated circuit, a computer program, and a computer-readable storage medium.

Furthermore, in the exemplary embodiment, the terminal information is described as, but is not limited to, the identification information and the service selection menu of external device 200. For example, the terminal information may be any information as long as the information relates to external device 200.

Further, in the exemplary embodiment, the terminal information is described as, but is not limited to, the information whose display position and/or display content (e.g., antenna pictogram) are altered according to a change in a communication quality of radiowaves. For example, the terminal information may be changed to a warning message (e.g., “The communication quality is deteriorated”) or the like as the display position of the external device moves from the position in FIG. 4 to the position in FIG. 8. With this, the user is able to adjust the orientation of the wireless communicating apparatus intuitively. Moreover, in the case shown in FIG. 10, the terminal information may be changed to a warning message “Losing the connection. Please move the apparatus so that the device is displayed in the center”, for example. With this, it is possible to prevent discontinuation of communication, and to execute a service or the like with high communication quality Q. In addition, examples of modification of the display content may include a change in a size of the terminal information, and blurring of the terminal information.

Furthermore, in the exemplary embodiment, if the image pick-up sensor is able to obtain parallax, the movement amount of the terminal information may be adjusted using parallax as described below.

Specifically, first, a distance from wireless communicating apparatus 100 to external device 200 is obtained using parallax. Then, the movement amount of the terminal information on display 120 is adjusted based on the obtained distance and the movement amount of device main body 190. In other words, a movement amount of external device 200 closer to wireless communicating apparatus 100 and a movement amount of external device 200 distant from wireless communicating apparatus 100 are different on display 120 even if the movement amount of device main body 190 is the same. Therefore, a distance to external device 200 is obtained using parallax. Then, the movement amount of external device 200 on display 120 is determined. In this manner, the movement amount of the terminal information on display 120 may be adjusted. As a result, even when there are both external devices 200 closer to wireless communicating apparatus 100 and external device 200 distant from wireless communicating apparatus 100, it is possible to display these external devices appropriately according to communication quality Q.

Further, this exemplary embodiment describes an example of the method in which controller 150 allows display 120 to display first external device 200A in the center of display 120 when communication quality Q is maximum value Qmax; on the other hand, controller 150 allows display 120 to display first external device 200A near the edge of display 120 when communication quality Q is minimum value Qmin; and then, the display position of first external device 200A corresponding to communication quality Q is linearly-interpolated between maximum value Qmax and minimum value Qmin to determine the display position of the terminal information. However, the present disclosure is not limited to such an example. For example, based on higher-order interpolation of communication quality Q, the display position of the terminal information may be determined. Specifically, it is possible to display the terminal information so that the terminal information smoothly moves, by providing inertia scrolling in a mobile browser.

Moreover, according to this exemplary embodiment, wireless communicating device 140 is configured such that the line of sight in wireless communication is identical with optical axis L of optical system 111, but the configuration of wireless communicating device 140 is not limited to this example. For example, as long as there is no problem in communication quality Q, the line of sight and optical axis L may be displaced. However, if the line of sight and optical axis L are identical, communication quality Q is maximized when external device 200 is displayed in the center of display 120. Therefore, this configuration is more favorable, as this facilitates determination of whether or not the orientation of device main body 190 is appropriate.

Furthermore, this exemplary embodiment takes, but is not limited to, the example in which radiowave radiation angle α of wireless communicating device 140 is contained within the field angle of optical system 111. For example, radiowave radiation angle α may be greater than the field angle. With this, it is possible to provide the same effect even when the field angle becomes narrow by zooming of the camera or the like.

Further, according to this exemplary embodiment, controller 150 first allows display 120 to display the terminal information in the center of display 120 as the initial position, but the configuration of controller 150 is not limited to this example. For example, the initial position of the terminal information may be optional. With this, the terminal information may be displayed at a position at which the operation is facilitated, for example. In addition, by displaying the terminal information at a position displaced from the center, it is possible to motivate the user to move the apparatus to the center direction in which the communication quality increases. As a result, it is possible to optimize the communication quality.

Moreover, this exemplary embodiment takes, but is not limited to, the example in which external device 200 is displayed on display 120 from the beginning. For example, if external device 200 is not displayed on display 120 at the start of imaging, it is possible to show a message “Please move wireless communicating apparatus (this apparatus) within a range in which an external device is displayed” may be displayed on display 120. Then, the terminal information of the external device may be displayed after the movement. With this, it is possible to perform initial adjustment between the external device and the wireless communicating apparatus.

Furthermore, this exemplary embodiment takes, but is not limited to, the example in which the terminal information is moved along a long side direction of wireless communicating apparatus 100 according to communication quality Q. For example, the terminal information may be moved along a short side direction of wireless communicating apparatus 100 when wireless communicating apparatus 100 is inclined back and forth. In addition, the terminal information may be moved according to the motion of wireless communicating apparatus 100, toward an outer circumferential edge of display 120 in any direction (right-left, up-down, or diagonally). With this, it is possible to make the user move attitude of wireless communicating apparatus 100 so that wireless communicating apparatus 100 is more accurately directed to a direction of higher communication quality Q.

Further, this exemplary embodiment takes, but is not limited to, the example in which one external device 200 is displayed on display 120. For example, when first external device 200A and second external device 200B are imaged and displayed on display 120 as illustrated in FIG. 1, terminal information of an external device with higher communication quality Q may be displayed on display 120. In this case, this state is maintained until a predetermined service with the first set external device is completed, even when communication quality Q of the other external device becomes higher as the attitude of wireless communicating apparatus 100 changes. Then, preferably, when the predetermined service is completed, terminal information of the other external device is displayed. In addition, a plurality of external devices such as first external device 200A and second external device 200B may be displayed on display 120 at the same time.

It should be understood that the exemplary embodiments described above are provided merely to exemplify the technique according to the present disclosure, and various modifications, replacements, additions, omissions, and the like may be made within the scope of the appended claims and equivalence thereof.

What is claimed is:

1. A wireless communicating apparatus comprising:
a wireless communicating device configured to perform directional wireless communication with an external device;
a display for displaying information that relates to the external device; and
a controller configured to control a display position of the information that relates to the external device,
wherein the controller moves the display position toward an edge from a current display position, when a quality of the communication with the external device deteriorates.

2. The wireless communicating apparatus according to claim 1, wherein
the information that relates to the external device is information for operating the external device.

3. The wireless communicating apparatus according to claim 1, wherein
the controller maintains the display position of the information, when the quality of the communication with the external device improves.

4. The wireless communicating apparatus according to claim 1, further comprising:
a sensor configured to detect motion of the wireless communicating apparatus,
wherein a displayed content on the display is updated when the sensor detects the motion.

5. The wireless communicating apparatus according to claim 4, wherein
the controller moves the display position toward a direction opposite of a direction of the motion detected by the sensor, when the quality of the communication deteriorates.

6. The wireless communicating apparatus according to claim 1, further comprising:
an image pick-up sensor configured to obtain an image,
wherein an optical axis of the image pick-up sensor is identical with a communication direction of the wireless communicating device.
